(19) United States
(12) Patent Application Publication
(10) Pub. No.: US 2008/0143239 A1
(43) Pub. Date: Jun. 19, 2008

(54) Image display device

(76) Inventors: Masaki Nishikawa, Chiba (JP); Masahiro Nishizawa, Mobara (JP); Hidetsugu Matsukiyo, Chiba (JP); Go Saitou, Mobara (JP); Toshimitsu Watanabe, Yokohama (JP)

Correspondence Address: REED SMITH LLP;Suite 1400, 3110 Fairview Park Drive, Falls Church, VA, 22042, US

(21) Appl. No.: 11/896,995

(22) Filed: Sep. 7, 2007

(30) Foreign Application Priority Data
Sep. 8, 2006 (JP) 2006-243671

(51) Int. Cl. H01J 1/62

(52) U.S. Cl. 313/495

(57) ABSTRACT

The present invention provides an image display device which can acquire a favorable white balance. In the image display device including a first substrate which has a plurality of electron emitting elements, and a second substrate which is arranged to face the first substrate in an opposed manner and has phosphors of three colors consisting of red, green and blue which emit lights upon excitation thereof by electrons emitted from the electron emitting elements, the phosphors of three colors consisting of red, green and blue which emit the lights upon excitation thereof by the electrons emitted from the electron emitting elements displaying 9300K which is standard white of NTSC, an excitation current density ratio of red, green and blue is set to a value which falls within a range of red:green:blue=95-105:100:95-105.

### CLAIM OF PRIORITY

The present application claims priority from Japanese Application JP 2006-243671 filed on Sep. 8, 2006, the content of which is hereby incorporated by reference into this application.

### BACKGROUND OF THE INVENTION

1. Field of the Invention

The present invention relates to an image display device such as a field emission display (hereinafter referred to as FED) which is configured to acquire a favorable white balance.

2. Description of the Related Art

In a planar image display device which respectively excites phosphors of red, green and blue to make the phosphors emit lights and forms an image, there may be a case that a favorable white balance cannot be obtained due to the difference in light emission brightness among the phosphors of respective colors. With respect to such an image display device, as a prior art for acquiring the favorable white balance, there has been known a technique which is described in JP-A-2002-63847 (Japanese patent document 1) or JP-A-2003-249361 (Japanese patent document 2) (U.S. Pat. No. 6,900,597), for example. Patent document 1 describes a technique which increases an area of a blue phosphor compared to areas of phosphors of two other colors in a plasma display panel (PDP) in view of a fact that the brightness of the blue phosphor is relatively lower than the brightness of the green and red phosphors, while patent document 2 describes a technique which increases an area of a blue phosphor compared to areas of phosphors of two other colors in an organic EL also in view of the fact that the brightness of the blue phosphor is relatively lower than the brightness of the green and red phosphors.

[Patent Document 1] JP-A-2002-63847

[Patent Document 2] JP-A-2003-249361 (U.S. Pat. No. 6,900,597)

The PDP makes the phosphors emit lights by exciting the phosphors using ultraviolet rays generated by a plasma discharge, while the FED makes the phosphors emit lights by exciting the phosphors using electron beams emitted from an electron emitting element. That is, the PDP and the FED differ from each other in the manner of exciting the phosphors, and the PDP and the FED differ from each other in kinds and materials of the phosphors to be used. As the phosphors to be used in the PDP, for example, the red phosphor made of (Y, Gd) BO₃:Eu, the green phosphor made of ZnSiO₄:Mn, and the blue phosphor made of BaMgAl₁₀O₁₇:Eu are used. At the time of performing a white display, the brightness of blue is relatively low when the brightness of green is used as the reference.

On the other hand, as the phosphors to be used in the FED, for example, the red phosphor made of Y₂O₃:Eu, the green phosphor made of Y₂SiO₅:Tb, and the blue phosphor made of ZnS:Ag, Cl are used. At the time of performing a white display, the brightness of red and the brightness of blue are relatively high when the brightness of green is used as the reference. Accordingly, it is difficult to obtain the favorable white balance even when the technique described in patent document 1 is applied to the FED.

Patent document 2 discloses that the technique for setting the area of the blue phosphor larger than the areas of other two colors is also applicable not only to the organic EL but also to the FED. However, as described above, with respect to the phosphors used in the FED, the brightness of green is lower than the brightness of red and the brightness of blue and hence, even when such a technique is applied to the FED, it is difficult to obtain the favorable white balance.

### SUMMARY OF THE INVENTION

The present invention has been made to overcome the above-mentioned conventional drawbacks and it is an object of the present invention to provide an image display device which can acquire a favorable white balance.

To achieve such an object, the present invention is directed to an image display device which includes a first substrate which has a plurality of electron emitting elements and a second substrate which is arranged to face the first substrate in an opposed manner and has phosphors of three colors consisting of red, green and blue which emit lights upon excitation thereof by electrons emitted from the electron emitting elements, and in which the phosphors of three colors consisting of red, green and blue which emit the lights upon excitation thereof by the electrons emitted from the electron emitting elements display 9300K which is standard white of NTSC, an excitation current density ratio of red, green and blue is set to a value which falls within a range of red:green:blue=95-105:100:95-105. Accordingly, it is possible to approximate a light emission brightness ratio of red, green and blue to a desired brightness ratio thus overcoming the drawbacks of the related art.

### BRIEF DESCRIPTION OF THE DRAWINGS

FIG. 1 is a view showing current dependency of phosphor brightness (brightness-current curve) for explaining a basic concept of an image display device according to the present invention;

FIG. 2 is an enlarged cross-sectional view of an essential part of a phosphor screen showing the constitution of one embodiment of the image display device according to the present invention;

FIG. 3 is an enlarged cross-sectional view of an essential part of a phosphor screen showing the constitution of another embodiment of the image display device according to the present invention;

FIG. 4A and FIG. 4B are views of a phosphor screen showing the constitution of still another embodiment of the image display device according to the present invention, wherein FIG. 4A is a plan view of an essential part as viewed from the inside, and FIG. 4B is an enlarged cross-sectional view of an essential part;

FIG. 5 is a view showing transmissivity curves in respective regions of red, green and blue; and

FIG. 6 is an enlarged cross-sectional view of an essential part of a phosphor screen showing the constitution of another embodiment of the image display device according to the present invention.

### DESCRIPTION OF THE PREFERRED EMBODIMENTS

The present invention is directed to an image display device which includes a first substrate which has a plurality of electron emitting elements and a second substrate which is arranged to face the first substrate in an opposed manner and has phosphors of three colors consisting of red, green and blue which emit lights upon excitation thereof by electrons emitted from the electron emitting elements, and in which the phosphors of three colors consisting of red, green and blue which emit the lights upon excitation thereof by the electrons emitted from the electron emitting elements display 9300K which is standard white of NTSC, an excitation current density ratio of red, green and blue is set to a value which falls within a range of red:green:blue=95-105:100:95-105. Accordingly, it is possible to approximate a light emission brightness ratio of red, green and blue to a desired brightness ratio thus overcoming the drawbacks of the related art.

The present invention is also directed to another image display device which includes a first substrate which has a plurality of electron emitting elements and a second substrate which is arranged to face the first substrate in an opposed manner and has phosphors of three colors consisting of red, green and blue which emit lights upon excitation thereof by electrons emitted from the electron emitting elements, and in which the phosphors of three colors consisting of red, green and blue which emit the lights upon excitation thereof by the electrons emitted from the electron emitting elements display 6500K which is white of NTSC, an excitation current density ratio of red, green and blue is set to a value which falls within a range of red:green:blue=95-105:100:95-105. Accordingly, it is possible to approximate a light emission brightness ratio of red, green and blue to a desired brightness ratio thus overcoming the drawbacks of the related art.

The present invention is also directed to still another image display device which includes a first substrate which has a plurality of electron emitting elements and a second substrate which is arranged to face the first substrate in an opposed manner and has phosphors of three colors consisting of red, green and blue which emit lights upon excitation thereof by electrons emitted from the electron emitting elements, and in which the phosphors of three colors consisting of red, green and blue which emit the lights upon excitation thereof by the electrons emitted from the electron emitting elements display 13000K which is white of NTSC, an excitation current density ratio of red, green and blue is set to a value which falls within a range of red:green:blue=95-105:100:95-105. Accordingly, it is possible to approximate a light emission brightness ratio of red, green and blue to a desired brightness ratio thus overcoming the drawbacks of the related art.

In the above-mentioned constitution, a layer having color selection property may preferably be formed on a front surface of the phosphor of one color or on front surfaces of the phosphors of a plurality of colors.

Further, in the above-mentioned constitution, a pigment having color selection property may preferably be adhered to the front surface of the phosphor of one color or to front surfaces of the phosphors of a plurality of colors.

Further, in the above-mentioned constitution, out of the phosphors of three colors, coating areas of one or two phosphors may preferably be enlarged compared to a coating area of the phosphor which possesses the minimum coating area.

Further, in the above-mentioned constitution, a filter having color selection property may preferably be arranged on a front surface of the second substrate.

Further, according to another image display device of the present invention, phosphors of three colors consisting of red, green and blue which emit lights upon excitation by electrons from an electron emitting element can set a plurality of whites, and a color selection filter which is exchangeable corresponding to setting of various whites is mounted on a front surface of the second substrate and hence, by displaying white when the corresponding color selection filter is used, an excitation current density ratio of the red, green and blue phosphors falls within a range of red:green:blue=95-105:100:95-105.

Here, the present invention is not limited to the above-mentioned respective constitutions and the constitutions described in embodiments explained later and various modifications are conceivable without departing from a technical concept of the present invention.

According to the image display device of the present invention, by setting the excitation current density ratio of red, green and blue to the value which falls within a range of red:green:blue=95-105:100:95-105, it is possible to approximate the light emission brightness ratio of red, green and blue to the desired brightness ratio and hence, it is possible to obtain an extremely excellent advantageous effect that whites ranging from low color temperature to high color temperature and a favorable white balance can be obtained.

Further, according to the image display device of the present invention, by forming the layer having color selection property on the front surface of the phosphor of one color or on the front surfaces of the phosphors of the plurality of colors or by adhering the pigment having color selection property to such front surfaces, or by performing both the formation of the layer and the adhesion of the pigment, it is possible to approximate the light emission brightness ratio of red, green and blue to a desired brightness ratio and hence, it is possible to approximate the excitation current density ratio to 1:1:1 whereby it is possible to obtain an extremely excellent advantageous effect that the gray scales can be maximized.

Further, according to the image display device of the present invention, by forming the layer having color selection property on the front surface of the phosphor of one color or on the front surfaces of the phosphors of the plurality of colors or by adhering the pigment having color selection property to such front surfaces, or by performing both the formation of the layer and the adhesion of the pigment, color purities of the respective colors can be enhanced whereby it is possible to obtain an extremely excellent advantageous effect that color reproduction range can be enlarged.

Further, according to the image display device of the present invention, by adhering the pigment having color selection property to the front surface of the phosphor, the phosphor can be protected and hence, it is possible to obtain an extremely excellent advantageous effect that a lifetime of the phosphor can be prolonged.

Hereinafter, specific embodiments of the present invention are explained in detail in conjunction with drawings which show the embodiments.

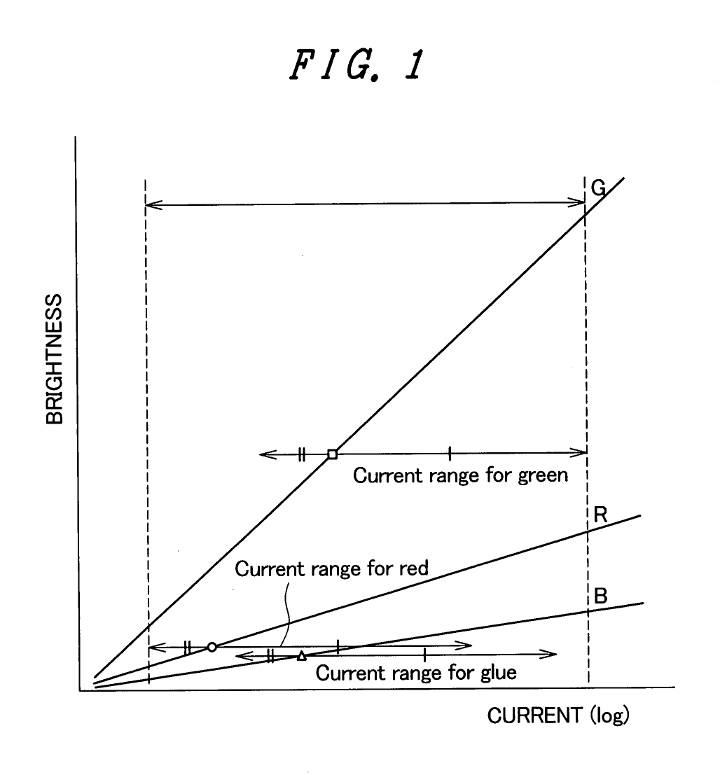

Here, prior to the explanation of the specific embodiments, a basic concept of the present invention is explained in conjunction with FIG. 1. Inclined straight lines shown in FIG. 1 indicate the current dependency of phosphor brightness (hereinafter, referred to as brightness-current curves). In general, the brightness of the phosphor is increased along with the increase of a current supplied to the phosphor. On the other hand, when desired white chromaticity and white brightness, and chromaticities of respective colors consisting of red (R), green (G) and blue (B) are determined, a brightness ratio of R, G, B is univocally determined by calculation.

When desired brightnesses are plotted on the brightness-current curves for respective colors, usually, as understood from an R plotted point indicated by a circular mark, a G plotted point indicated by a square mark and a B plotted point indicated by a triangular mark in FIG. 1, values of currents to be supplied to the phosphors differ from each other. It is necessary to maintain the brightness ratio of R, G and B and hence, as can be clearly understood from FIG. 1, current ranges which are actually used in respective colors become narrower than a current variable range of an FED electron emitting element.

Here, assume that the current variable range of the FED electron emitting element can be controlled in 256 stages. In this case, the current ranges which can be actually used for respective colors are narrower than the current variable range of the FED electron emitting element and hence, it is possible to control the respective colors only in 256 stages or below. Accordingly, the number of display gray scales of each color is decreased and, as the matter of course, the number of display gray scales as a whole is also decreased.

To overcome such a drawback, the phosphor screen structure is improved as explained later in paragraphs (1) to (4) thus obtaining the desired brightnesses of the respective colors by changing the brightness-current curves per se. Here, in the actual phosphor, the brightness-current curves do not take straight lines. However, in FIG. 1, for the sake of brevity, the brightness-current curves are expressed as straight lines. Further, although the light emitting chromaticities are also changed, for the sake of brevity, the light emitting chromaticities are considered unchanged in this specification. Although such differences may generate a trivial deviation as described also in the embodiments, the basic concept of the present invention that the current values to be supplied are approximated to 1:1:1 at R:G:B corresponding to respective colors is not influenced by such differences.

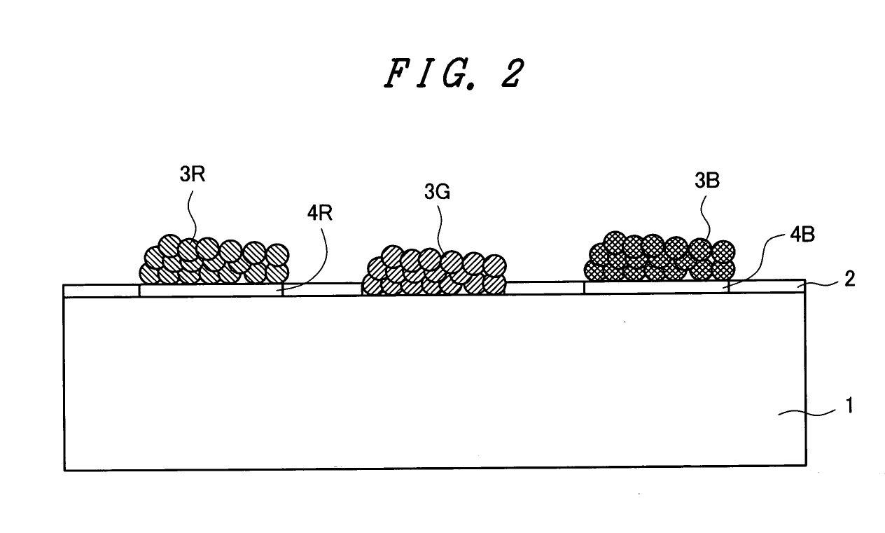

FIG. 2 is an enlarged cross-sectional view of an essential part of a phosphor screen formed inside a second substrate. Numeral 1 indicates a light transmissive glass panel which constitutes the second substrate, numeral 2 indicates a black matrix film formed on an inner side of the glass panel 1 at predetermined positions, numerals 3R, 3G, 3B indicate a red phosphor, a green phosphor and a blue phosphor which are respectively formed on the inner side of the glass panel 1 while being defined by the black matrix film 2, and numerals 4R, 4B respectively indicate inner-surface filters which are formed between the red phosphor 3R and the glass panel as well as between a blue phosphor 3B and the glass panel.

As the above-mentioned means for improving the phosphor screen structure, the following constitution (1) is considered.

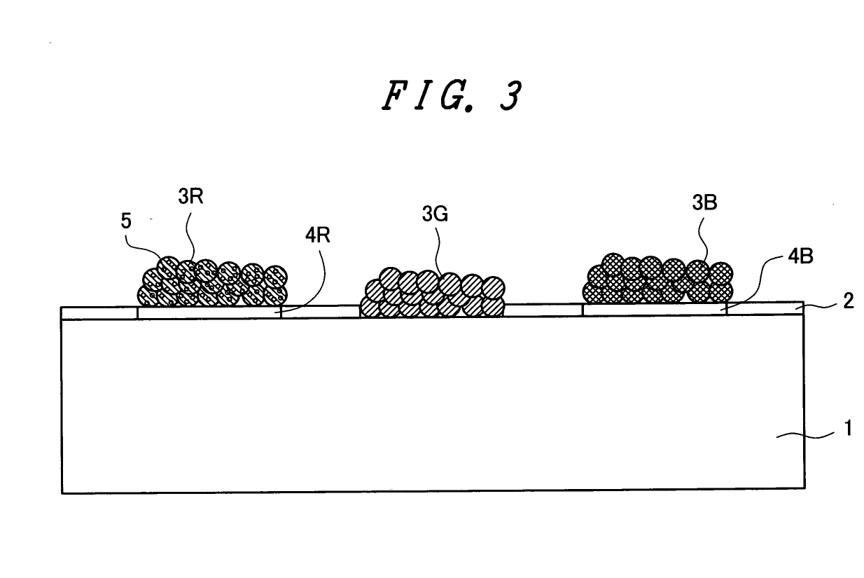

(1) As shown in FIG. 2, the inner-surface filter 4R and the inner-surface filter 4B are arranged only on the red phosphor 3R and the blue phosphor 3B of colors which exhibit less required current values. Further, as shown in FIG. 3, in addition to the arrangement of the inner-surface filter 4R and the inner-surface filter 4B, a pigment 5 is adhered to surfaces of particles of the red phosphor 3R. Using such a means, an excitation current density ratio of red, green and blue when white is to be displayed is adjusted to approximate R:G:B=1:1:1. Due to such adjustment, it is possible to effectively make use of the whole current variable range of the FED electron emitting element thus maximizing gray scales. Further, simultaneously with the adjustment of the excitation current density ratio, due to the color selection effect obtained by the pigment and the inner-surface filter, the color purity of the phosphor with small required current value is enhanced thus enlarging a color reproducible range.

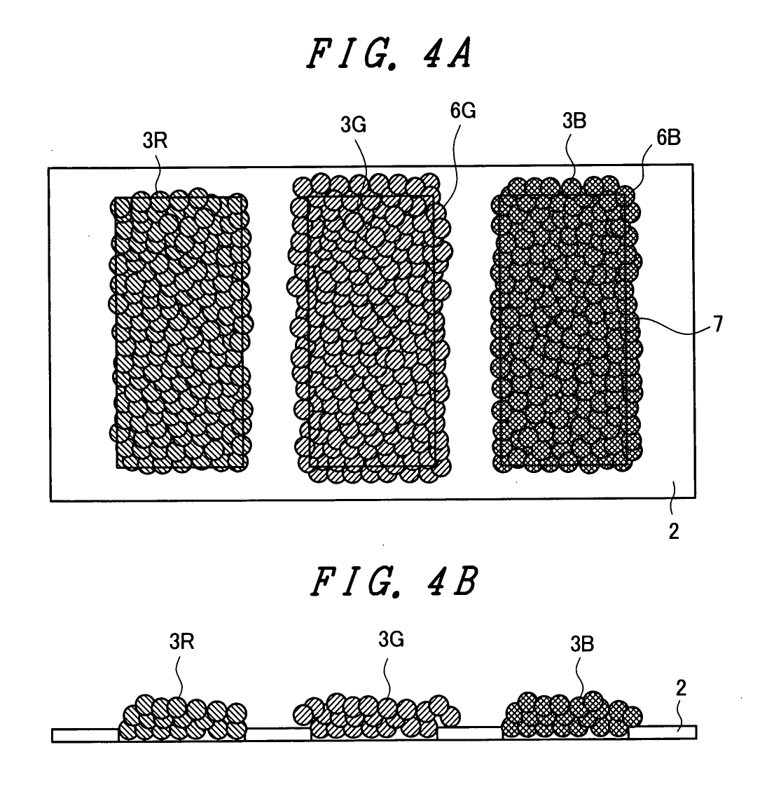

FIG. 4A and FIG. 4B are views for explaining the constitution of the phosphor screen formed inside the second substrate, wherein FIG. 4A is a plan view of an essential part as viewed from the inside, and FIG. 4B is an enlarged cross-sectional view of an essential part. In these drawings, parts identical with the parts shown in FIG. 3 are given same symbols, and their explanation is omitted. In the drawings, numerals 6G and 6B indicate projecting portions of the green phosphor 3G and the blue phosphor 3B which respectively project to the outside from opening portions 7.

Further, as another means for improving the above-mentioned phosphor screen structure, the following constitution (2) is considered.

(2) As shown in FIG. 4, phosphor projecting portions 6G, 6B which project more toward the black-matrix-film-2 side are formed on colors which exhibit more required currents. Areas of the projecting portions 6G, 6B are increased along with the increase of the required currents. By increasing the areas of colors which exhibit the large required currents, the brightnesses are increased. Using such a means, an excitation current density ratio of red, green and blue when white is to be displayed is adjusted to approximate R:G:B=1:1:1. Here, for preventing color mixing, projecting distances of the phosphors are set to values equal to or less than film thicknesses of the phosphors measured from an end of the black matrix film 2.

Further, as still another means for improving the above-mentioned phosphor screen structure, the following constitution (3) is considered.

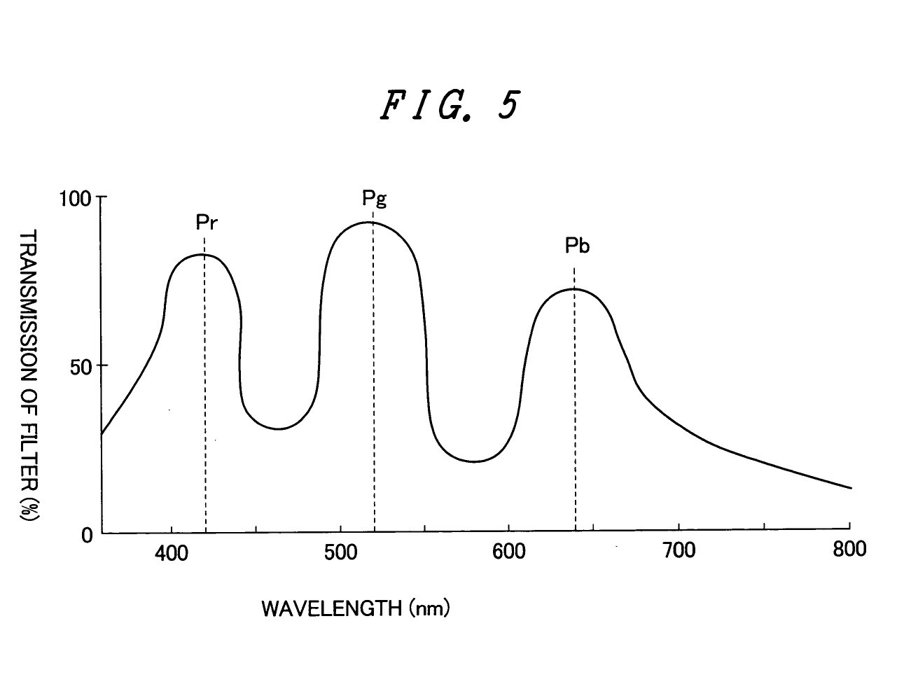

(3) A filter having peak values Pr, Pg, Pb of transmissivities in respective regions of red, green, blue shown in FIG. 5 is arranged on a surface (outer surface) of the glass panel 1. The transmissivities of the filter are preliminarily adjusted to set the excitation current density ratio of red, green, blue when white is to be displayed such that the excitation current density ratio approximates R:G:B=1:1:1.

Further, as another means for improving the above-mentioned phosphor screen structure, the following constitution (4) is considered.

(4) The excitation current density ratio of red, green, blue when white is to be displayed by combining the above-mentioned means (1) to (3) is set to approximate R:G:B=1:1:1.

### Embodiment 1

Next, the embodiment 1 is explained in detail in conjunction with drawings. The phosphor screens are formed by using the red phosphor: Y₂O₃:Eu, the green phosphor: Y₂SiO₅:Tb, the blue phosphor: ZnS:Ag, Cl, for example, as the phosphors used in the FED. The phosphor screen is excited with electron beams emitted from electron emitting elements used in the FED. With an acceleration voltage of approximately 7 kV, when the respective phosphor screens are excited with the same current density, the brightness ratio is R:G:B=380:1150:190. Further, chromaticities (x, y) of respective colors are (0.639, 0.347) in red, (0.345, 0.577) in green, (0.148, 0.067) in blue.

When the phosphor screen areas of the respective pixels of red, green and blue are equal under the above-mentioned condition, to set white chromaticity (x, y) to (0.283, 0.298), the current density ratio of the currents supplied with respect to respective colors becomes R:G:B=56:100:89 and hence, it is necessary to supply larger currents to the green and blue phosphor screens. Here, the reason that the current density ratio takes the above-mentioned value is that the brightnesses which are required by the green and the blue phosphor screens is higher than the actual brightnesses of green and blue phosphor screens. It is desirable to approximate the above-mentioned current density ratio to R:G:B=1:1:1 as much as possible from a viewpoint of enhancing the utilization efficiency of the electron emitting element and ensuring display colors.

To overcome the above-mentioned drawbacks, as shown in FIG. 2, between the glass panel 1 and the red phosphor screen as well as between the glass panel 1 and the blue phosphor screen, the inner-surface filter 4R and the inner-surface filter 4B are respectively arranged. Due to such a constitution, the chromaticity (x, y) of red becomes (0.656, 0.343), and the chromaticity of blue becomes (0.146, 0.063). Further, the brightness ratio of red, green and blue becomes R:G:B=306:1150:159. By setting the white chromaticity (x, y) to (0.283, 0.298) (=color temperature 9300K (standard white of NTSC)) and the white brightness to 200 cd/m² (standard condition on design), the current density ratio of the currents supplied with respect to respective colors becomes R:G:B=65:100:98.

### Embodiment 2

To approximate the current density ratio to 1:1:1, this embodiment uses the phosphors which adhere a pigment on surfaces of particles of the red phosphor screen in addition to the arrangement of the inner-surface filter 4R and the inner-surface filter 4B between the glass panel 1 and the red phosphor screen as well as between the glass panel 1 and the blue phosphor screen performed in the embodiment 1 as shown in FIG. 3. Due to such a constitution, the chromaticity (x, y) of red becomes (0.664, 0.343). Further, the brightness ratio of red, green and blue becomes R:G:B=199:1150:159. By setting the white chromaticity (x, y) to (0.283, 0.298) (=color temperature 9300K) and white brightness to 200 cd/m² (approximately middle white under standard condition on design), the current density ratio of the currents supplied with respect to respective colors becomes R:G:B=95:100:97.

Here, by setting the white brightness to 20 cd/m² (dark white under standard condition on design) with the same white chromaticity, the current density ratio becomes R:G:B=93:100:95, while by setting the white brightness to 500 cd/m² (bright white under standard condition on design) with the same white chromaticity, the current density ratio becomes R:G:B=101:100:104. This result is attributed to the fact that the shapes of the brightness-current curves on the respective phosphor screens differ from each other.

### Embodiment 3

To approximate the current density ratio to 1:1:1, as shown in FIG. 4A which is the plan view of the phosphor screen and FIG. 4B which is the cross-sectional view of the phosphor screen, phosphor coating areas of the green phosphor 3G and the blue phosphor 3B are set larger than a phosphor coating area of the red phosphor 3R. Here, to prevent color mixing, the respective distances of the projecting portions 66G, 6B are set to values equal to or less than thicknesses of the green phosphor 3G and the blue phosphor 3B. Due to such constitution, although the chromaticities are not changed, the brightnesses of green and blue are elevated in appearance and hence, the difference of the current density ratio can be decreased.

By setting the white chromaticity (x, y) to (0.283, 0.298) (color temperature 9300K) and white brightness to 200 cd/m², the current density ratio of the currents supplied with respect to respective colors becomes R:G:B=95:100:100. Further, by setting the white brightness to 20 cd/m² with the same white chromaticity, the current density ratio becomes R:G:B=93:100:97, while by setting the white brightness to 500 cd/m² with the same white chromaticity, the current density ratio becomes R:G:B=101:100:107.

In such constitution, the chromaticities of the phosphors are not changed. Accordingly, with respect to the chromaticities (x,y) of respective colors, the chromaticity of red becomes (0.639, 0.347), the chromaticity of green becomes (0.345, 0.577), and the chromaticity of blue becomes (0.148, 0.067). In the phosphor screen structure which is actually manufactured, the minimum NTSC ratio of the color reproduction range is approximately 61.7%.

### Embodiment 4

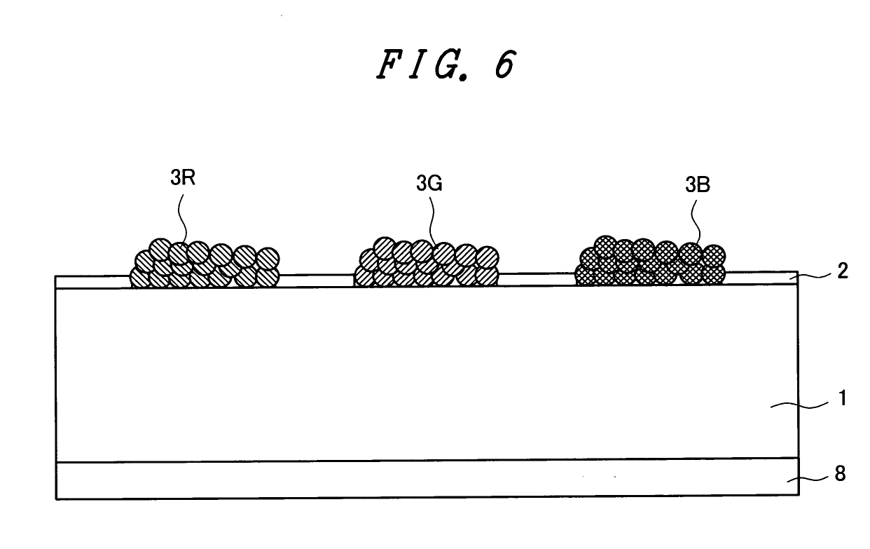

To approximate the current density ratio to 1:1:1, a filter 8 having the peaks Pr, Pg, Pb of the transmissivities in the respective regions of red, green and blue as shown in FIG. 5 is arranged on a front surface of the glass panel 1 as shown in FIG. 6. By setting the white chromaticity (x, y) to (0.283, 0.298) (=color temperature 9300K) and white brightness to 200 cd/m², the current density ratio of the currents supplied with respect to respective colors becomes R:G:B=100:100:95. Here, by setting the white brightness to 20 cd/m² with the same white chromaticity, the current density ratio becomes R:G:B=98:100:92, while by setting the white brightness to 500 cd/m² with the same white chromaticity, the current density ratio becomes R:G:B=102:100:99.

To approximate the current density ratio to 1:1:1, the areas of the above-mentioned pigment-applied phosphors, the inner-surface filters and the phosphor projecting portions are controlled and the front-surface filter is arranged. By setting the white chromaticity (x, y) to (0.283, 0.298) (=color temperature 9300K) and white brightness to 200 cd/m², the current density ratio of the currents supplied with respect to respective colors becomes R:G:B=100:100:100. Here, by setting the white brightness to 20 cd/m² with the same white chromaticity, the current density ratio becomes R:G:B=99:100:99, while by setting the white brightness to 500 cd/m² with the same white chromaticity, the current density ratio becomes R:G:B=101:100:101.

### Embodiment 6

Samples are made to determine whether it is possible to approximate the current density ratio to 1:1:1 using a method similar to the method of the embodiment 5 or not even when, as standard conditions on design, the white color temperature is set to 6500K (European standard) or 13000K (JIS: bluish white), and the white brightness is set to 200 cd/m². As a matter of course, even under such conditions, by controlling the areas of the pigment-applied phosphors, the inner-surface filters and the phosphor projecting portions and by arranging the front-surface filter, the current density ratio of the currents supplied with respect to the respective colors can be set to R:G:B=100:100:100. Also in this case, by setting the white brightness to 20 cd/m² with the same white chromaticity, the current density ratio becomes R:G:B=99:100:99, while by setting the white brightness to 500 cd/m² with the same white chromaticity, the current density ratio becomes R:G:B=101:100:101.

### Embodiment 7

The phosphor screens are formed by using the red phosphor: Y₂O₂S:Eu, the green phosphor: ZnS:Cu, Al, and the blue phosphor: ZnS:Ag, Cl as the phosphors used in the FED. The phosphor screen is excited with electron beams emitted from electron emitting elements used in the FED. With an acceleration voltage of approximately 7 kV, when the respective phosphor screens are excited with the same current density, the brightness ratio is R:G:B=370:1180:190. Further, chromaticities (x, y) of respective colors are (0.654, 0.335) in red, (0.288, 0.613) in green, (0.146, 0.064) in blue.

When the phosphor screen areas of the respective pixels of red, green and blue are equal under the above-mentioned condition, to set white chromaticity (x, y) to (0.283, 0.298), the current density ratio of the currents supplied with respect to respective colors becomes R:G:B=90:100:92 and hence, it is necessary to supply larger currents to the green pixels and the blue pixels.

The reason that the current density ratio assumes the above-mentioned value is that the brightnesses which are required by the red pixel and the blue pixel are higher than actual brightnesses of the red pixel and the blue pixel. It is desirable to approximate the above-mentioned current density ratio to 1:1:1 as much as possible from a view point of enhancing the utilization efficiency of the electron emitting element and ensuring display colors. To overcome the above-mentioned drawbacks, pigment-applied phosphors are used as a red and green phosphors. Further, the inner-surface filter is arranged between the inner surface of the glass panel and the phosphor screen.

Due to such a constitution, the chromaticity (x, y) of red becomes (0.661, 0.335), the chromaticity (x, y) of green becomes (0.287, 0.622), and the chromaticity of blue becomes (0.146, 0.056). Further, the brightness ratio of red, green and blue becomes R:G:B=254:982:118. By setting the white chromaticity(x, y) to (0.283,0.298) (=color temperature 9300K), and white brightness to 200 cd/m², the current density ratio of the currents supplied with respect to respective colors becomes R:G:B=104:100:105. In this case, in the phosphor screen structure which is actually manufactured, the maximum NTSC ratio of the color reproduction range is approximately 79.7%.

### Embodiment 8

This embodiment can set standard whites which differ from each other. In setting the respective standard whites, to approximate the excitation current density ratios to 1:1:1 corresponding to the respective colors, a plurality of exchangeable face filters is arranged corresponding to the respective colors. The face filters are manufactured such that when the white brightness is set to 200 cd/m² in the respective color temperatures of 6500K, 9300K and 13000K, the current density ratio of the currents supplied with respect to the respective colors becomes R:G:B=100:100:100. This embodiment arranges a reeling device which automatically arranges the filter corresponding to the set color temperature when the color temperature is set.

What is claimed is:

1. An image display device comprising:
a first substrate which has a plurality of electron emitting elements; and
a second substrate which is arranged to face the first substrate in an opposed manner and has phosphors of three colors consisting of red, green and blue which emit lights upon excitation thereof by electrons emitted from the electron emitting elements, wherein
the phosphors of three colors consisting of red, green and blue which emit the lights upon excitation thereof by the electrons emitted from the electron emitting elements displaying 9300K which is standard white of NTSC,
an excitation current density ratio of red, green and blue is set to a value which falls within a range of red:green:blue=95-105:100:95-105.

2. An image display device according to claim 1, wherein a layer having color selection property is formed on a front surface of the phosphor of one color or on front surfaces of the phosphors of a plurality of colors.

3. An image display device according to claim 1, wherein a pigment having color selection property is adhered to the phosphor of one color or to the phosphors of a plurality of colors.

4. An image display device according to claim 1, wherein coating areas of one or two phosphors are enlarged compared to a coating area of the phosphor which possesses the minimum coating area out of the phosphors of three colors.

5. An image display device according to claim 1, wherein a filter having color selection property is arranged on a front surface of the second substrate.

6. An image display device comprising:
a first substrate which has a plurality of electron emitting elements; and
a second substrate which is arranged to face the first substrate in an opposed manner and has phosphors of three colors consisting of red, green and blue which emit lights upon excitation thereof by electrons emitted from the electron emitting elements, wherein
the phosphors of three colors consisting of red, green and blue which emit the lights upon excitation thereof by the electrons emitted from the electron emitting elements displaying 6500K which is white of NTSC,
the excitation current density ratio of red, green and blue is set to a value which falls within a range of red:green:blue=95-105:100:95-105.

7. An image display device according to claim 6, wherein a layer having color selection property is formed on a front surface of the phosphor of one color or on front surfaces of the phosphors of a plurality of colors.

8. An image display device according to claim 6, wherein a pigment having color selection property is adhered to the phosphor of one color or to the phosphors of a plurality of colors.

9. An image display device according to claim 6, wherein coating areas of one or two phosphors are enlarged compared to a coating area of the phosphor which possesses the minimum coating area out of the phosphors of three colors.

10. An image display device according to claim 6, wherein a filter having color selection property is arranged on a front surface of the second substrate.

11. An image display device comprising:
a first substrate which has a plurality of electron emitting elements; and
a second substrate which is arranged to face the first substrate in an opposed manner and has phosphors of three colors consisting of red, green and blue which emit lights upon excitation thereof by electrons emitted from the electron emitting elements, wherein
the phosphors of three colors consisting of red, green and blue which emit the lights upon excitation thereof by the electrons emitted from the electron emitting elements displaying 13000K which is white of NTSC,
the excitation current density ratio of red, green and blue is set to a value which falls within a range of red:green:blue=95-105:100:95-105.

12. An image display device according to claim 11, wherein a layer having color selection property is formed on a front surface of the phosphor of one color or on front surfaces of the phosphors of a plurality of colors.

13. An image display device according to claim 11, wherein a pigment having color selection property is adhered to the phosphor of one color or to the phosphors of a plurality of colors.

14. An image display device according to claim 11, wherein coating areas of one or two phosphors are enlarged compared to a coating area of the phosphor which possesses the minimum coating area out of the phosphors of three colors.

15. An image display device according to claim 11, wherein a filter having color selection property is arranged on a front surface of the second substrate.

16. An image display device comprising:
a first substrate which has a plurality of electron emitting elements; and
a second substrate which is arranged to face the first substrate in an opposed manner and has phosphors of three colors consisting of red, green and blue which emit lights upon excitation thereof by electrons emitted from the electron emitting elements, wherein
a plurality of whites can be set using phosphors of three colors consisting of red, green and blue which emit lights upon excitation by electrons from the electron emitting element, and a color selection filter which is exchangeable corresponding to setting of various whites is formed on a front surface of the second substrate, and by displaying white when the corresponding color selection filter is used, an excitation current density ratio with respect to the red, green and blue phosphors falls within a range of red:green:blue=95-105:100:95-105.
